(19) United States
(12) Patent Application Publication
(10) Pub. No.: US 2025/0381592 A1
(43) Pub. Date: Dec. 18, 2025

(54) ULTRA-HIGH-SPEED DUAL CUTTING SYSTEM AND SECONDARY BATTERY ULTRA-HIGH-SPEED DUAL CUTTING

(71) Applicant: MPLUS CORP., Cheongju-si (KR)

(72) Inventors: Jong Sung KIM, Seongnam-si (KR); Jin Kyu JUN, Cheongju-si (KR); Yun Gi KIM, Gumi-si (KR); Jae Myeong KIM, Cheongju-si (KR)

(73) Assignee: MPLUS CORP., Cheongju-si (KR)

(21) Appl. No.: 19/229,991

(22) Filed: Jun. 5, 2025

(30) Foreign Application Priority Data
Jun. 13, 2024 (KR) 10-2024-0077003

(51) Int. Cl. B21D 43/28; B21D 28/14; B65H 16/02; B65H 20/02; H01M 4/70

(52) U.S. Cl. CPC B21D 43/287; B21D 28/14; B65H 16/02; B65H 20/02; H01M 4/70

(57) ABSTRACT

An object of the present disclosure is to provide a system for cutting an electrode 10 (negative/positive) delivered in reel form at a constant pitch during a notching process of a secondary battery manufacturing process, and a configuration of the present disclosure includes an electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 supplied by the electrode feeder 130, and a secondary cutting unit 150 that secondarily cuts the electrode 10 supplied from the primary cutting unit 140.

An effect of the present disclosure is that equipment that cuts the electrode 10 supplied in reel form at an ultra-high speed with a constant pitch suited to product specifications, performs external inspection, and loads acceptable and defective products into magazines enables production at more than twice the throughput of conventionally used equipment.

### CROSS-REFERENCE TO RELATED APPLICATIONS

This application claims priority from Korean Patent Application No. 10-2024-0077003, filed on Jun. 13, 2024, in the Korean Intellectual Property Office, the disclosure of which is incorporated herein by reference in its entirety.

### BACKGROUND

### 1. Field

The present disclosure relates to an ultra-high-speed dual cutting system and an ultra-high-speed dual cutting method for secondary batteries, and more specifically, to an ultra-high-speed dual cutting system and an ultra-high-speed dual cutting method for secondary batteries for maximizing production of secondary batteries by securing a novel cutting technology in a notching process of a secondary battery to replace a cutting unit compared to conventional equipment.

### 2. Description of Related Art

A secondary battery is generally manufactured by interposing separators between a plurality of positive plates having positive polarity and a plurality of negative plates having negative polarity to stack the positive plates and the negative plates (electrodes) in multiple layers.

In this case, the electrode is configured in a substantially rectangular plate shape and includes an electrode tab on one side; a reel electrode wound on a supply part such as a supply bobbin (or roller) is unwound and fed lengthwise, electrode tabs are formed at predetermined intervals on one side of the reel electrode, and the reel electrode having the electrode tabs is cut at appropriate positions to produce the electrode in the rectangular plate shape, so an apparatus for cutting the elongated reel electrode provided with the electrode tabs into the electrode in the rectangular plate shape is essentially required.

A conventional electrode-cutting apparatus is configured so that an upper cutter and a lower cutter slide relative to each other with inner faces abutting, and blades provided on the upper cutter and the lower cutter cut the electrode for a secondary battery.

### PRIOR ART REFERENCES

### Patent Documents

Korean Laid-open Patent No. 10-1999-018729 (Published on Mar. 15, 1999)

Korean Registered Patent No. 10-1857096 (Registered on May 4, 2018)

### BRIEF SUMMARY

An object of the present disclosure is to provide an ultra-high-speed dual cutting system and an ultra-high-speed dual cutting method for secondary batteries for securing optimized cutting quality such as burr and debris generated during ultra-high-speed cutting and for incorporating a high-speed inspection vision system.

The ultra-high-speed dual cutting system for secondary batteries comprises an electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 fed by the electrode feeder 130, and a secondary cutting unit 150 that secondarily cuts the electrode 10 supplied from the primary cutting unit 140.

The electrode supply unit 120 includes a pre-feeding frame 122 disposed on an inlet side where the electrode 10 of a secondary battery is introduced, a pre-feeding bobbin 124 rotatably mounted on the pre-feeding frame 122 and having the electrode 10 of a secondary battery wound on an outer circumferential surface thereof, a pre-feeding roller 126 disposed in front of the pre-feeding bobbin 124, and a notching die 128, which is a two-cavity die, disposed between the pre-feeding roller 126 and the electrode feeder 130.

The pre-feeding roller 126 comprises an upper pre-feeding roller 126A and a lower pre-feeding roller 126B that rotate in opposite directions so that the electrode 10 passes over outer circumferential surfaces thereof, and the electrode feeder 130 comprises a master feeder 132 disposed in front of the notching die 128, a secondary feeder 134 disposed in front of the master feeder 132, and a sub-feeder 136 disposed in front of the secondary feeder 134.

The master feeder 132 includes a pair of an upper master feeding roller 132A and a lower master feeding roller 132B that rotate in opposite directions so that both faces of the electrode 10 fed over outer circumferential surfaces of the upper pre-feeding roller 126A and the lower pre-feeding roller 126B forming the pre-feeding roller 126 contact and pass over outer circumferential surfaces thereof.

The secondary feeder 134 includes a pair of an upper secondary feeding roller 134A and a lower secondary feeding roller 134B that rotate in opposite directions so that both faces of the electrode 10 having passed over outer circumferential surfaces of the upper master feeding roller 132A and the lower master feeding roller 132B forming the master feeder 132 contact and pass over outer circumferential surfaces thereof.

The sub-feeder 136 includes a pair of an upper sub-feeding roller 136A and a lower sub-feeding roller 136B that rotate in opposite directions so that both faces of the electrode 10 fed over outer circumferential surfaces of the upper secondary feeding roller 134A and the lower secondary feeding roller 134B forming the secondary feeder 134 contact and pass over outer circumferential surfaces thereof.

The primary cutting unit 140 is disposed between the master feeder 132 and the secondary feeder 134, and the primary cutting unit 140 includes a primary-cutting support frame 142, a primary-cutting elevating device 144 mounted on the primary-cutting support frame 142, and a primary cutter 146 that moves up and down by the primary-cutting elevating device 144.

The secondary cutting unit 150 is disposed between the secondary feeder 134 and the sub-feeder 136, and the secondary cutting unit 150 includes a secondary-cutting support frame 152 disposed, with respect to a conveying direction of the electrode 10, in front of the primary-cutting support frame 142, a secondary-cutting elevating device 154 mounted on the secondary-cutting support frame 152, and a secondary cutter 156 that moves up and down by the secondary-cutting elevating device 154, thereby providing the ultra-high-speed dual cutting system for secondary batteries as a solution to the problem.

According to the present disclosure for solving the aforementioned problem, a ultra-high-speed dual cutting method for secondary batteries, using a ultra-high-speed dual cutting system for secondary batteries comprising an electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 fed by the electrode feeder 130, and a secondary cutting unit 150 that secondarily cuts the electrode 10 supplied from the primary cutting unit 140, comprises an electrode-feeding step of feeding the electrode 10 of a secondary battery from the electrode supply unit 120, a pre-primary-cutting feeding step of feeding the electrode 10 to the primary cutting unit 140 by the electrode feeder 130, a primary cutting step of primarily cutting the electrode 10 by the primary cutting unit 140, a post-primary-cutting feeding step of feeding the primarily cut electrode 10 to the secondary feeder 134 and the sub-feeder 136, a secondary cutting step of secondarily cutting the electrode 10 by the secondary cutting unit 150, and a secondary-cutting feeding step of feeding the secondarily cut electrode 10 to the secondary feeder 134, thereby providing the ultra-high-speed dual cutting method for secondary batteries as a solution to the problem.

### EFFECTS OF THE INVENTION

The present disclosure enables equipment that cuts the electrode supplied in reel form at an ultra-high speed with a constant pitch suited to product specifications, performs external inspection, and loads acceptable and defective products into magazines to achieve more than twice the throughput of conventional equipment. In other words, the present disclosure can improve production capacity compared with conventional cutting equipment through the development of a cutting method and structure for secondary batteries.

### BRIEF DESCRIPTION OF THE DRAWINGS

FIG. 1 is a plan view schematically illustrating a process of cutting an electrode using the ultra-high-speed dual cutting system for secondary batteries according to the present disclosure.

FIG. 2 is a plan view schematically illustrating a continuous process of cutting an electrode using the ultra-high-speed dual cutting system for secondary batteries according to the present disclosure.

FIG. 3 is a front view showing the structure of the ultra-high-speed dual cutting system for secondary batteries according to the present disclosure.

FIG. 4 is an enlarged front view showing the structure of the electrode supply unit, which is a main part, depicted in FIG. 3.

FIG. 5 is a front view schematically illustrating the structure and operating mechanism of the notching die, the master feeder, the secondary feeder, the sub-feeder, the primary cutting unit, and the secondary cutting unit of the electrode supply unit, which is a main part of the ultra-high-speed dual cutting system for secondary batteries according to the present disclosure.

FIG. 6 is a front view schematically illustrating the structure of the notching die, the master feeder, the secondary feeder, the sub-feeder, the primary cutting unit, and the secondary cutting unit of the electrode supply unit, which is a main part of the ultra-high-speed dual cutting system for secondary batteries according to the present disclosure.

FIG. 7 is an enlarged view of a main portion shown in FIG. 6.

### DETAILED DESCRIPTION OF THE INVENTION

Hereinafter, preferred embodiments of the present disclosure will be described in detail with reference to the accompanying drawings. The objectives, features, and advantages of the present disclosure will become more readily apparent from the accompanying drawings and the following detailed description. In addition, in describing the present disclosure, detailed explanations of well-known configurations or functions will be omitted when they might obscure the gist of the present disclosure.

In addition, in describing components of the present disclosure, terms such as first, second, A, B, (a), and (b) may be used. These terms serve only to distinguish one component from another and do not limit the nature, order, or sequence of the components. When a component is described as being connected, coupled, or joined to another component, the component may be directly connected or joined, but it should be understood that another component may be connected, coupled, or joined therebetween.

In addition, specific structural or functional descriptions presented herein are merely illustrative of embodiments conceived according to the concept of the present disclosure; embodiments according to the concept of the present disclosure may be implemented in various forms and should not be construed as being limited to the embodiments described in this specification or application.

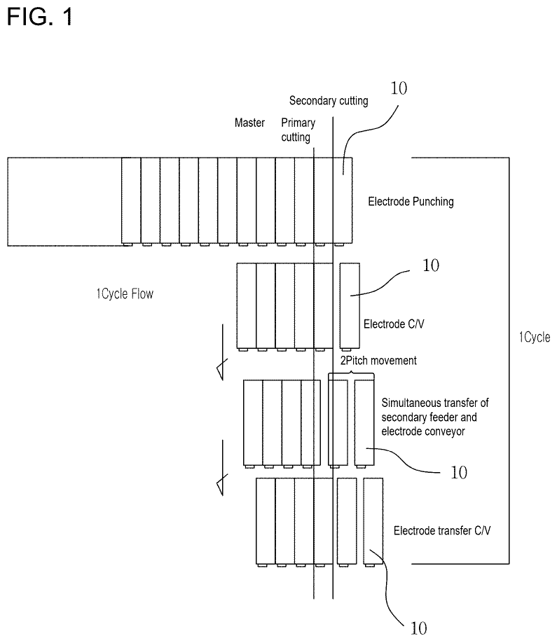

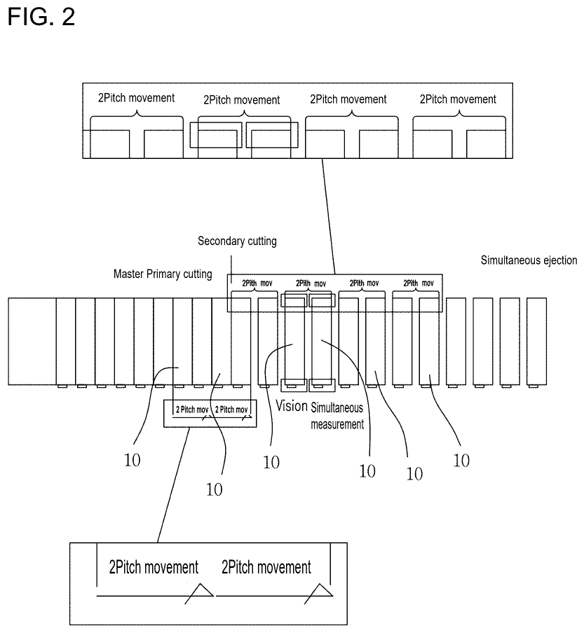

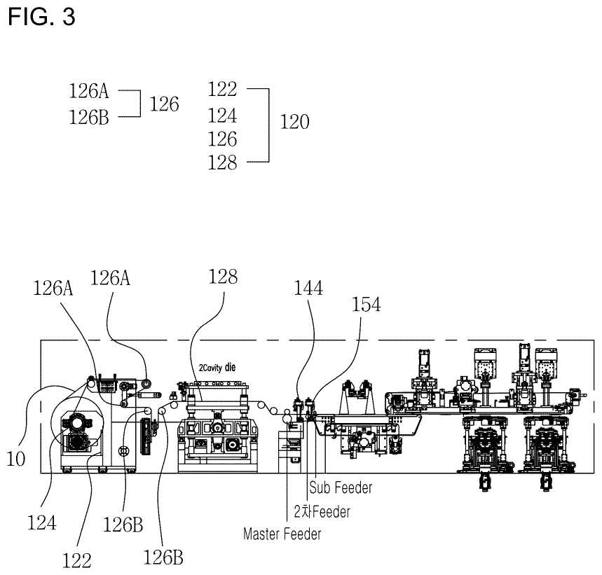

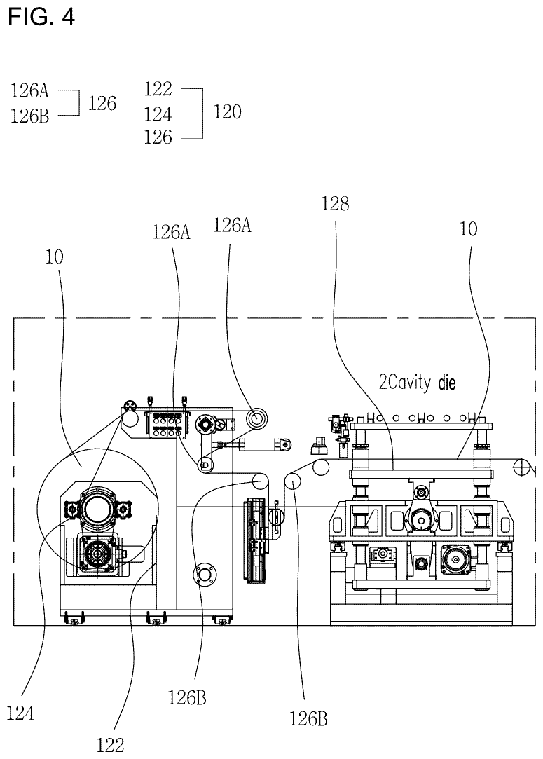

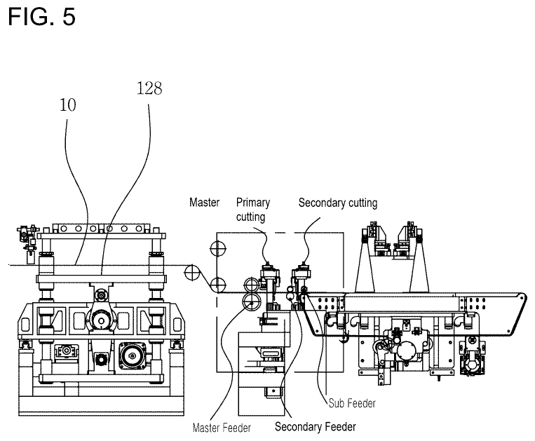

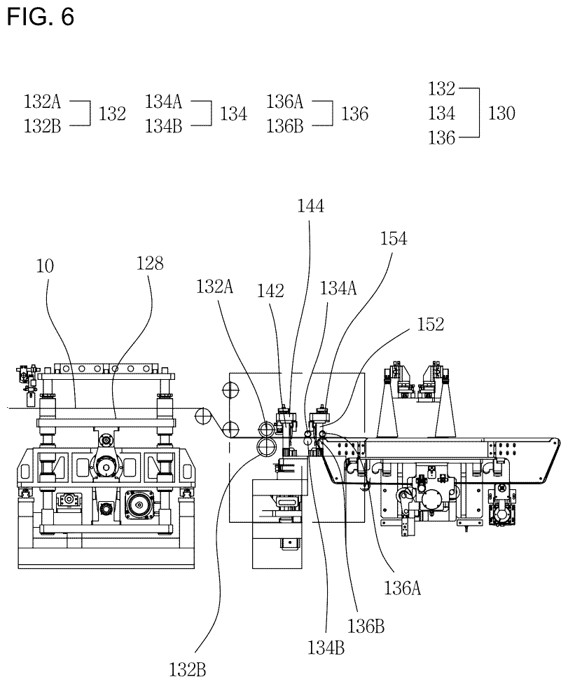

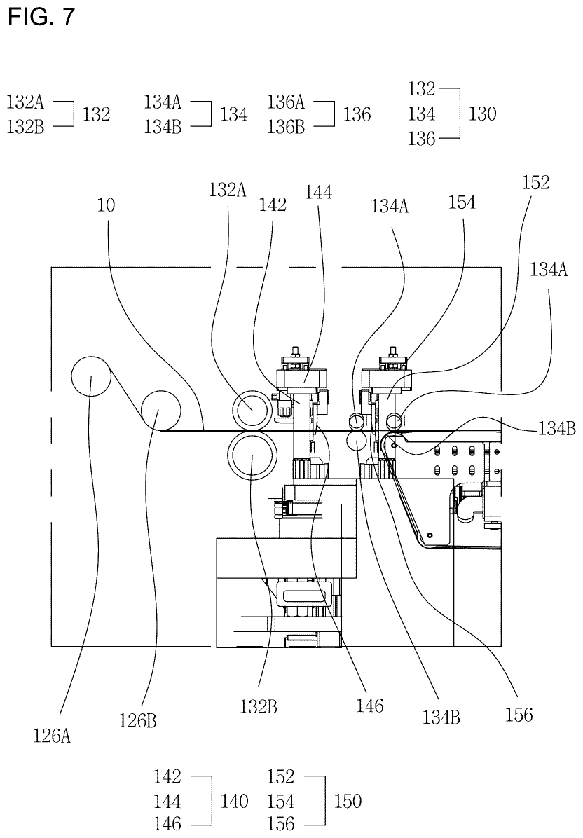

FIG. 1 is a plan view schematically illustrating a process of cutting an electrode using the ultra-high-speed dual cutting system for secondary batteries according to the present disclosure, FIG. 2 is a plan view schematically illustrating a continuous process of cutting an electrode using the ultra-high-speed dual cutting system for secondary batteries according to the present disclosure, FIG. 3 is a front view showing the structure of the ultra-high-speed dual cutting system for secondary batteries according to the present disclosure, FIG. 4 is an enlarged front view showing the structure of the electrode supply unit, which is a main part, depicted in FIG. 3, FIG. 5 is a front view schematically illustrating the structure and operating mechanism of the notching die, the master feeder, the secondary feeder, the sub-feeder, the primary cutting unit, and the secondary cutting unit of the electrode supply unit according to the present disclosure, FIG. 6 is a front view schematically illustrating the structure of the notching die, the master feeder, the secondary feeder, the sub-feeder, the primary cutting unit, and the secondary cutting unit of the electrode supply unit, which is a main part of the ultra-high-speed dual cutting system for secondary batteries according to the present disclosure, and FIG. 7 is a view showing an enlarged view of a main portion of FIG. 6.

Referring to the drawings, the ultra-high-speed dual cutting system for secondary batteries according to the present disclosure includes the electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 fed by the electrode feeder 130, and a secondary cutting unit 150 that secondarily cuts the electrode 10 supplied from the primary cutting unit 140 as a basic configuration, and feeds the electrode 10 of a secondary battery from the electrode supply unit 120, feeds the electrode 10 to the primary cutting unit 140 by the electrode feeder 130, primarily cuts the electrode 10 by the primary cutting unit 140, and secondarily cuts the electrode 10 by the secondary cutting unit 150.

Meanwhile, in the present disclosure, the electrode supply unit 120 includes a pre-feeding frame 122 disposed on an inlet side where the electrode 10 of a secondary battery is introduced, a pre-feeding bobbin 124 rotatably mounted on the pre-feeding frame 122 and having the electrode 10 of a secondary battery wound on an outer circumferential surface thereof, a pre-feeding roller 126 disposed in front of the pre-feeding bobbin 124, and a notching die 128 (a two-cavity die) disposed between the pre-feeding roller 126 and the electrode feeder 130.

By way of further explanation, an electrode 10 transport conveyor is disposed between the electrode supply unit 120 and the sub-feeder 136 disposed in front of the secondary cutting unit 150 (with respect to an electrode 10 conveying line along which the electrode 10 of a secondary battery travels), so that the electrode 10 can be conveyed from an electrode 10 inlet end to an electrode 10 outlet end by the electrode 10 transport conveyor.

At this time, a discharge guide conveyor described below is disposed in front of the electrode 10 outlet end, so that the electrode 10 secondarily cut by the secondary cutting unit 150 can be conveyed by the discharge guide conveyor.

The electrode supply unit includes a pre-feeding frame 122, a pre-feeding bobbin 124, and a pre-feeding roller 126.

The notching die 128 (a two-cavity die) is a die that has two cavities formed to notch two electrodes simultaneously, and has two cavities formed inside the die, and can notch a plurality of electrodes 10 by adding a secondary feeder 134 within the electrode feeder 130 for a higher speed.

The pre-feeding frame 122 is disposed on an inlet side where the electrode 10 of a secondary battery is introduced.

The pre-feeding bobbin 124 is rotatably mounted on the pre-feeding frame 122. The electrode 10 of a secondary battery is wound on an outer circumferential surface of the pre-feeding bobbin 124.

At this time, a bobbin shaft at a center of the pre-feeding bobbin 124 is mounted on the pre-feeding frame 122 via a relative-rotation supporting means such as a bearing, so that the pre-feeding bobbin 124 is rotatably mounted on the pre-feeding frame 122, and a rotation drive motor is mounted on the pre-feeding frame 122, and a bobbin shaft at a center of the pre-feeding bobbin 124 is connected to a motor shaft of the rotation drive motor via a power-transmission means such as a gear or a coupler, so that the pre-feeding bobbin 124 rotates in one direction (namely, a direction in which the electrode 10 wound on an outer circumferential surface is fed along an electrode 10 conveying line) by rotation of the motor shaft of the rotation drive motor, thereby enabling the electrode 10 to be fed along the electrode 10 conveying line.

The pre-feeding roller 126 is disposed in front of the pre-feeding bobbin 124. With respect to the electrode 10 conveying line along which the electrode 10 of a secondary battery is transported, the pre-feeding roller 126 is disposed in front of the pre-feeding bobbin 124.

At this time, the pre-feeding roller 126 comprises an upper pre-feeding roller 126A and a lower pre-feeding roller 126B that rotate in opposite directions so that the electrode 10 passes over outer circumferential surfaces thereof, and the electrode feeder 130 comprises a master feeder 132 disposed in front of the notching die 128, a secondary feeder 134 disposed in front of the master feeder 132, and a sub-feeder 136 disposed in front of the secondary feeder 134.

The notching die 128 is disposed between the pre-feeding roller 126 and the electrode feeder 130. The notching die 128 is a two-cavity die that forms tabs on the electrode 10 transported along an electrode 10 conveying line by performing a notching operation.

The electrode feeder 130 includes a master feeder 132, a secondary feeder 134, and a sub-feeder 136.

The master feeder 132 is disposed in front of the notching die 128. With respect to an electrode 10 conveying line along which the electrode 10 of a secondary battery is transported, the master feeder 132 is disposed in front of the notching die 128.

The secondary feeder 134 is disposed in front of the master feeder 132. With respect to an electrode 10 conveying line along which the electrode 10 of a secondary battery is transported, the secondary feeder 134 is disposed in front of the master feeder 132.

The sub-feeder 136 is disposed in front of the secondary feeder 134. With respect to the electrode 10 conveying line along which the electrode 10 of a secondary battery is transported, the sub-feeder 136 is disposed in front of the secondary feeder 134.

At this time, the master feeder 132 includes a pair of an upper master feeding roller 132A and a lower master feeding roller 132B that rotate in opposite directions so that both faces of the electrode 10, fed via outer circumferential surfaces of the upper pre-feeding roller 126A and the lower pre-feeding roller 126B forming the pre-feeding roller 126, contact and pass over outer circumferential surfaces.

In addition, the secondary feeder 134 includes a pair of an upper secondary feeding roller 134A and a lower secondary feeding roller 134B that rotate in opposite directions so that both faces of the electrode 10, having passed over outer circumferential surfaces of the upper master feeding roller 132A and the lower master feeding roller forming the master feeder 132, contact and pass over outer circumferential surfaces.

In addition, the sub-feeder 136 includes a pair of an upper sub-feeding roller 136A and a lower sub-feeding roller 136B that rotate in opposite directions so that both faces of the electrode 10, fed via outer circumferential surfaces of the upper secondary feeding roller 134A and the lower secondary feeding roller 134B forming the secondary feeder 134, contact and pass over outer circumferential surfaces.

Meanwhile, in the present disclosure, a primary cutting unit 140 is disposed between the master feeder 132 and the secondary feeder 134, and the primary cutting unit 140 includes a primary-cutting support frame 142, a primary-cutting elevating device 144 mounted on the primary-cutting support frame 142, and a primary cutter 146 that moves up and down by the primary-cutting elevating device 144.

The primary cutting unit 140 is disposed, with respect to a conveying direction of the electrode 10, in front of the master feeder 132.

At this time, the primary-cutting elevating device 144 is configured as a primary-cutting cylinder whose cylinder rod is oriented vertically, so that the primary cutter 146 is mounted on the cylinder rod of the primary-cutting cylinder, and the primary cutter 146 moves downward by descent of the cylinder rod of the primary-cutting cylinder to primarily cut the electrode 10 fed beneath it.

In addition, a secondary cutting unit 150 is disposed between the secondary feeder 134 and the feeding unit 136, and the secondary cutting unit 150 includes a secondary-cutting support frame 152 disposed, with respect to the conveying direction of the electrode 10, in front of the primary-cutting support frame 142, a secondary-cutting elevating device 154 mounted on the secondary-cutting support frame 152, and a secondary cutter 156 that moves up and down by the secondary-cutting elevating device 154.

At this time, the secondary-cutting elevating device 154 is configured as a secondary-cutting cylinder whose cylinder rod is oriented vertically, so that the secondary cutter 156 is mounted on the cylinder rod of the secondary-cutting cylinder, and the secondary cutter 156 moves downward by descent of the cylinder rod of the secondary-cutting cylinder to secondarily cut the electrode 10 fed beneath it. The electrode 10 primarily cut is secondarily cut.

Meanwhile, the present disclosure further includes a discharge guide conveyor and a vision device.

The discharge guide conveyor is disposed in front of the sub-feeder 136. With respect to the electrode 10 conveying line, the discharge guide conveyor is disposed in front of the sub-feeder 136, so that the electrode 10 secondarily cut by the secondary cutting unit 150 is fed toward the discharge guide conveyor by the sub-feeder 136, the electrode 10 is conveyed by the discharge guide conveyor, and the vision device determines whether the electrode 10 is defective, ejects the defective electrode 10 by a defective product ejection device (NG-ejection device) when the electrode 10 is defective, and feeds the acceptable electrode 10 to a next process line by the discharge guide conveyor.

For reference, in the present disclosure, a side where the electrode 10 enters is referred to as an electrode 10 inlet end, and a side where the electrode 10 exits is referred to as an electrode 10 outlet end, the electrode 10 is conveyed along an electrode 10 conveying path between the electrode 10 inlet end and the electrode 10 outlet end, and the electrode supply unit 120, the electrode feeder 130, the primary cutting unit 140, the secondary cutting unit 150, and the discharge guide conveyor, which are main parts in the present disclosure, are configured to be disposed sequentially from the electrode 10 inlet end toward the electrode 10 outlet end. Meanwhile, according to the present disclosure, the ultra-high-speed

dual cutting method for secondary batteries is provided using the ultra-high-speed dual cutting system for secondary batteries comprising an electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 fed by the electrode feeder 130, and a secondary cutting unit 150 that secondarily cuts the electrode 10 supplied from the primary cutting unit 140.

The ultra-high-speed dual cutting method for secondary batteries according to the present disclosure comprises an electrode-feeding step of feeding an electrode 10 of a secondary battery from the electrode supply unit 120, the pre-primary-cutting feeding step of feeding the electrode 10 to the primary cutting unit 140 by the electrode feeder 130, a primary cutting step of primarily cutting the electrode 10 by the primary cutting unit 140, a post-primary-cutting feeding step of feeding the primarily cut electrode 10 to the secondary feeder 134 and the sub-feeder 136, a secondary cutting step of secondarily cutting the electrode 10 by the secondary cutting unit 150, and a secondary-cutting feeding step of feeding the secondarily cut electrode 10 to the secondary feeder 134.

The process of ultra-high-speed cutting of the electrode 10 according to the configuration of the present disclosure is explained as follows.

In FIG. 1 and FIG. 2, a one-cycle flow of cutting the electrode 10 by the ultra-high-speed dual cutting system for secondary batteries according to the present disclosure is shown.

First, the electrode 10 having passed over outer circumferential surfaces of an upper pre-feeding roller 126A and a lower pre-feeding roller 126B of the electrode supply unit 120 passes over outer circumferential surfaces of an upper master feeding roller 132A and a lower master feeding roller 132B, the primary cutter 146 descends to primarily cut the electrode 10 with the electrode 10 stopped beneath the primary cutter 146, the electrode 10 passes over outer circumferential surfaces of an upper secondary feeding roller 134A and a lower secondary feeding roller 134B, the secondary cutter 156 descends to secondarily cut the electrode 10 with the primarily cut electrode 10 stopped beneath the secondary cutter 156, and the secondarily cut electrode 10 is fed toward a discharge guide conveyor via outer circumferential surfaces of an upper sub-feeding roller 136A and a lower sub-feeding roller 136B, and then the secondarily cut electrode 10 is fed to a next process line by the discharge guide conveyor.

Of course, as described above, the electrode 10 secondarily cut by the secondary cutter 150 is fed toward the discharge guide conveyor by the sub-feeder 136, the secondarily cut electrode 10 is conveyed by the discharge guide conveyor, the vision device determines whether the electrode 10 is defective, ejects the defective electrode 10 by an NG-ejection device when the electrode 10 is defective, and can feed the acceptable electrode 10 to a next process line by the discharge guide conveyor.

Therefore, the present disclosure enables equipment that cuts the electrode 10 supplied in reel form at an ultra-high speed with a constant pitch suited to product specifications, performs external inspection, and loads acceptable and defective products into magazines to achieve more than twice the throughput of conventional equipment.

The above-described present disclosure is not limited to the embodiments described above, and it will be understood by those skilled in the art to which the present disclosure pertains that various modifications and alterations can be made within a scope not changing the gist of the present disclosure.

Therefore, the embodiments described above are provided to fully inform those skilled in the art to which the present disclosure pertains of the scope of the invention, and should be understood as being illustrative in every respect and not restrictive, and the present disclosure is defined only by the scope of the claims.

DESCRIPTION OF REFERENCE NUMERALS

| | |
|---|---|
| 120 electrode supply unit | 122 pre-feeding frame |
| 124 pre-feeding bobbin | 126 pre-feeding roller |
| 126A upper pre-feeding roller | 126B lower pre-feeding roller |
| 128 notching die | 130 electrode feeder |
| 132 master feeder | 132A upper master feeding roller |
| 132B lower master feeding roller | 134 secondary feeder |
| 134A upper secondary feeding roller | 134B lower secondary feeding roller |
| 136 sub-feeder | 136A upper sub-feeding roller |
| 136B lower sub-feeding roller | 140 primary cutting unit |
| 142 primary-cutting support frame | 144 primary-cutting elevating device |
| 146 primary cutter | 150 secondary cutting unit |
| 152 secondary-cutting support frame | 154 secondary-cutting elevating device |
| 156 secondary cutter | |

What is claimed is:

1. An ultra-high-speed dual cutting system for secondary batteries comprising:
an electrode supply unit 120 that supplies an electrode 10 of a secondary battery,
an electrode feeder 130 that feeds the electrode 10 supplied from the electrode supply unit 120 for cutting,
a primary cutting unit 140 that primarily cuts the electrode 10 fed by the electrode feeder 130, and
a secondary cutting unit 150 that secondarily cuts the electrode 10 supplied from the primary cutting unit 140.

2. The ultra-high-speed dual cutting system for secondary batteries according to claim 1, wherein the electrode supply unit 120 includes:
a pre-feeding frame 122 disposed on an inlet side where the electrode 10 of a secondary battery is introduced,
a pre-feeding bobbin 124 rotatably mounted on the pre-feeding frame 122 and having the electrode 10 of a secondary battery wound on an outer circumferential surface thereof,
a pre-feeding roller 126 disposed in front of the pre-feeding bobbin 124, and
a notching die 128 (a two-cavity die) disposed between the pre-feeding roller 126 and the electrode feeder 130.

3. The ultra-high-speed dual cutting system for secondary batteries according to claim 2, wherein the pre-feeding roller 126 comprises an upper pre-feeding roller 126A and a lower pre-feeding roller 126B that rotate in opposite directions so that the electrode 10 passes over outer circumferential surfaces thereof, and
the electrode feeder 130 comprises:
a master feeder 132 disposed in front of the notching die 128,
a secondary feeder 134 disposed in front of the master feeder 132, and
a sub-feeder 136 disposed in front of the secondary feeder 134.

4. The ultra-high-speed dual cutting system for secondary batteries according to claim 3, wherein the master feeder 132 comprises:
the pair of an upper master feeding roller 132A and a lower master feeding roller 132B that rotate in opposite directions so that both faces of the electrode 10 fed over outer circumferential surfaces of the upper pre-feeding roller 126A and the lower pre-feeding roller 126B forming the pre-feeding roller 126 contact and pass over outer circumferential surfaces thereof.

5. The ultra-high-speed dual cutting system for secondary batteries according to claim 3, wherein the secondary feeder 134 comprises:
a pair of an upper secondary feeding roller 134A and a lower secondary feeding roller 134B that rotate in opposite directions so that both faces of the electrode 10 having passed over outer circumferential surfaces of the upper master feeding roller 132A and the lower master feeding roller 132B forming the master feeder 132 contact and pass over outer circumferential surfaces thereof.

6. The ultra-high-speed dual cutting system for secondary batteries according to claim 3, wherein the sub-feeder 136 comprises:
a pair of an upper sub-feeding roller 136A and a lower sub-feeding roller 136B that rotate in opposite directions so that both faces of the electrode 10 fed over outer circumferential surfaces of the upper secondary feeding roller 134A and the lower secondary feeding roller 134B forming the secondary feeder 134 contact and pass over outer circumferential surfaces thereof.

7. The ultra-high-speed dual cutting system for secondary batteries according to claim 3, wherein the primary cutting unit 140 is disposed between the master feeder 132 and the secondary feeder 134, and
the primary cutting unit 140 comprises:
a primary-cutting support frame 142,
a primary-cutting elevating device 144 mounted on the primary-cutting support frame 142, and
a primary cutter 146 that moves up and down by the primary-cutting elevating device 144.

8. The ultra-high-speed dual cutting system for secondary batteries according to claim 3, wherein the secondary cutting unit 150 is disposed between the secondary feeder 134 and the sub-feeder 136, and
the secondary cutting unit 150 comprises:
a secondary-cutting support frame 152 disposed, with respect to a conveying direction of the electrode 10, in front of the primary-cutting support frame 142,
a secondary-cutting elevating device 154 mounted on the secondary-cutting support frame 152, and
a secondary cutter 156 that moves up and down by the secondary-cutting elevating device 154.

9. An ultra-high-speed dual cutting method for secondary batteries using an ultra-high-speed dual cutting system for secondary batteries comprising an electrode supply unit 120 that supplies an electrode 10 of a secondary battery, an electrode feeder 130 that feeds the electrode 10 supplied from the electrode supply unit 120 for cutting, a primary cutting unit 140 that primarily cuts the electrode 10 fed by the electrode feeder 130, and a secondary cutting unit 150 that secondarily cuts the electrode 10 supplied from the primary cutting unit 140, the method comprising:
an electrode-feeding step of feeding the electrode 10 of a secondary battery from the electrode supply unit 120,
a pre-primary-cutting feeding step of feeding the electrode 10 to the primary cutting unit 140 by the electrode feeder 130,
a primary cutting step of primarily cutting the electrode 10 by the primary cutting unit 140,
a post-primary-cutting feeding step of feeding the primarily cut electrode 10 to a secondary feeder 134 and a sub-feeder 136,
a secondary cutting step of secondarily cutting the electrode 10 by the secondary cutting unit 150, and
a secondary-cutting feeding step of feeding the secondarily cut electrode 10 to the secondary feeder 134.
